(19) United States
(12) Patent Application Publication
(10) Pub. No.: US 2007/0118381 A1
(43) Pub. Date: May 24, 2007

(54) Voice control methods

(75) Inventors: Tien-ming Hsu, Taoyuan Hsien (TW); Liang-shen Huang, Taoyuan Hsien (TW); Yuan-chia Lu, Taoyuan Hsien (TW); Min-hong Wang, Taoyuan Hsien (TW); Jia-lin Shen, Taoyuan Hsien (TW)

Correspondence Address: Haverstock & Owens LLP, 162 North Wolfe Road, Sunnyvale, CA, 94086, US

(73) Assignee: Delta Electronics, Inc.

(21) Appl. No.: 11/454,331

(22) Filed: Jun. 16, 2006

(30) Foreign Application Priority Data
Nov. 22, 2005 (TW) 094141010

(51) Int. Cl. G10L 21/00

(52) U.S. Cl. 704/275

(57) ABSTRACT

Disclosed is a voice control method, by which a user may effectively control an electronic device to operate through a voice control input without the situation encountered where a voice control command can sometimes not be received and responded by the electronic device.

### FIELD OF THE INVENTION

The present invention relates to a voice control technology, and particularly to a voice control method for controlling an electronic device through a human-machine interface.

### BACKGROUND OF THE INVENTION

Voice control technology has been widely utilized to control electronic devices so that the electronics may execute functions which the users would like to have. However, since there has been no completely satisfactory human-machine interface hitherto, disadvantages still can be found in such voice control technology and the voice control technology can not control the electronic devices by identifying the input voices at its full length.

For controlling the electronic devices, the voice control technology may generally be performed in either of three modes, i.e. free-to-talk, push-to-talk and talk-to-talk. However, all the three modes are still disadvantageous as mentioned above. For the talk-to-talk mode, for instance, a keyword is given before an instruction proceeds, wherein the instruction is used to direct the electronic device to operate according thereto. Although no any mechanical button like is required to be pressed upon the electronic device or a remote control associated therewith and suitable for situations where no button is provided or button pressing is not convenient. However, the talk-to-talk mode is susceptible to erroneous rejection and erroneous acceptation. For example, when a user says “Waiter, play . . . ”, the dictation may sometimes not be sensed by the electronic device, making the voice control function not achieved as expected. At this time, the dictation is erroneously rejected. On the other hand, when the user talks with others, the electronic device may otherwise mistake some of the conversation between the user and the others as the dictation “Waiter, play . . . ”. Once the erroneous rejection times are too many, the user may lose patience and thus be frustrated by the use of the voice control function. Likewise, when too many times of such erroneous acceptation occur, the user may think the electronic device is not useful since no desired function is performed even after some times of dictations are issued.

Therefore, there is an urgent need to provide an effective voice control method so that drawbacks existing in the prior art may be improved and thus the electronic device may be more precisely controlled by the user. In response to this, the Inventors set forth a voice control method in the present invention after a series of intensive researches, experiments and tests, considerably enhancing efficiency of controlling the electronic device in speech sounds.

### SUMMARY OF THE INVENTION

It is, therefore, an object of the present invention to provide a voice control method by which a user may effectively control an electronic device to operate as desired through a voice control input without the situation encountered where a voice control command can sometimes not be received and responded by the electronic device.

According to one aspect of the present invention, the voice control method comprises the steps of speaking a predetermined keyword by the user and then speaking an dictation for controlling the electronic device to operate according thereto, inputting a predetermined action to direct the electronic device to issue a first response to the user indicating the predetermined action has been received when the electronic device has not received the predetermined keyword, and initializing a predetermined voice control function by the electronic device.

According to another aspect of the present invention, the voice control method comprises the steps of capturing an image of a front view with respect to the electronic device and initializing a voice control function when the image is determined as a predetermined image.

According to yet another aspect of the present invention, the voice control method comprises the steps of capturing a feature of the user and initializing a voice control function when the captured feature is identified.

With the above methods performed, the electronic device may be more precisely controlled by sound speech, as compared to the prior art, since the enhanced mechanism is provided where the feature inputted before the dictation is inputted can be identified by the electronic device.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods and disclosed or illustrated. In the drawings:

Some examples of voice control methods in accordance with the invention will now be described with reference to the accompanying drawings, in which:

FIG. 1 is a flowchart illustrating a voice control method performed in a back-off implementation according to the present invention;

FIG. 2 is a flowchart illustrating the voice control method performed in a robustness implementation according to the present invention; and

FIG. 3 is a flowchart illustrating the voice control method performed in a personalization implementation according to the present invention.

### DETAILED DESCRIPTION OF THE PREFERRED EMBODIMENT

The present invention discloses a voice control method taken with the preferred embodiments through which a person of the relevant art may implement the present invention in many other forms of embodiment. The embodiments disclosed in the following are merely preferred ones and should not be considered limitative in scope.

The voice control method for controlling an electronic device by a user comprises three implementations, i.e. back-off, robustness and personalization.

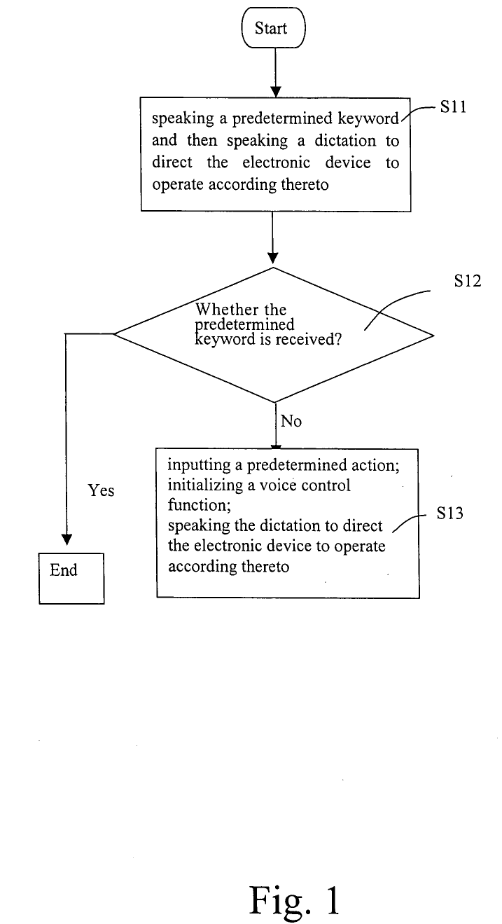

Referring to FIG. 1, a flowchart of the voice control method performed in a back-off implementation according to the present invention is illustrated therein. As shown, the user speaks a predetermined keyword before dictating the electronic device to operate as he/she desires by issuing a dictation. As such, the electronic device may be informed that a dictation will be soon issued from the user, and then speaking a dictation to direct the electronic device to operate according thereto. The keyword may be “waiter”, “computer” and any word or phrase such as brand of the electronic and the like. Then, the electronic device determines whether the predetermined keyword has been received (S12). If yes, the electronic device may optionally issue a response to the user so that the user may perceive that the electronic device has received the keyword and his dictation may be issued. That means the voice control function is initiated, and the dictation could direct the electronic device to operate according thereto (not shown). When the dictation is not received within a predetermined period after the keyword is received, the electronic device may optionally issue another response to prompt the user. As mentioned, the responses may be issued by the electronic device after the keyword and when the dictation is not received within a predetermined period after the keyword is received. Each of the response types may be a predetermined sound, a predetermined window and the like, and the responses may be identical to each other.

Otherwise, if the electronic device does not respond with respect to the keyword, the user may then input a predetermined action to dictate the electronic device to issue another response indicating the predetermined action has been received; a voice control function is initialized and the response indicating the predetermined action has been received; and at this time, the user may speak his dictation to direct the electronic device to operate according thereto (S13). The predetermined action may be a button pressing action, a clapping action and the like. The response of the electronic device after the input of the predetermined action may be the same as or different from that after the keyword is spoken out.

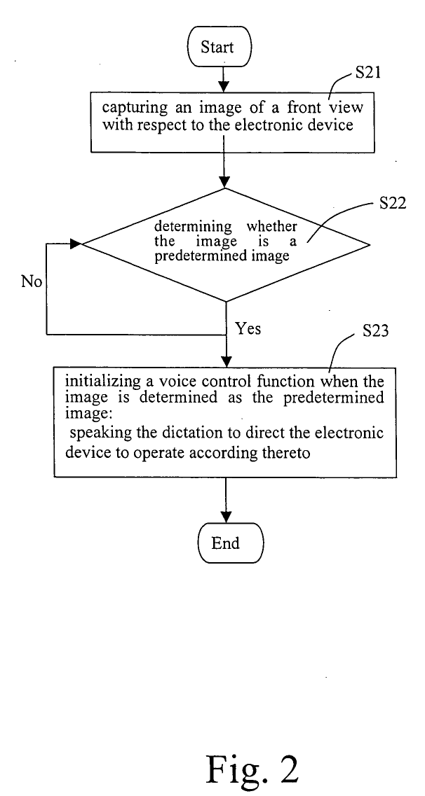

Referring to FIG. 2, a flowchart illustrating the voice control method performed in a robustness implementation according to the present invention is shown therein. At first, the electronic device captures an image of a front view with respect to the electronic device (S21). Next, the image is determined as being a predetermined image or not (S22). When the image is determined as the predetermined image, a voice control function is initialized; at this time, the user may speak his dictation and the electronic device is directed to operate according thereto (S23). The predetermined image may be an object image, a person image, a predetermined gesture image, a hand waving image, an image of a line of sight of the user and the like. In capturing the image in front of the electronic device, the electronic device is generally set to a stand-by mode.

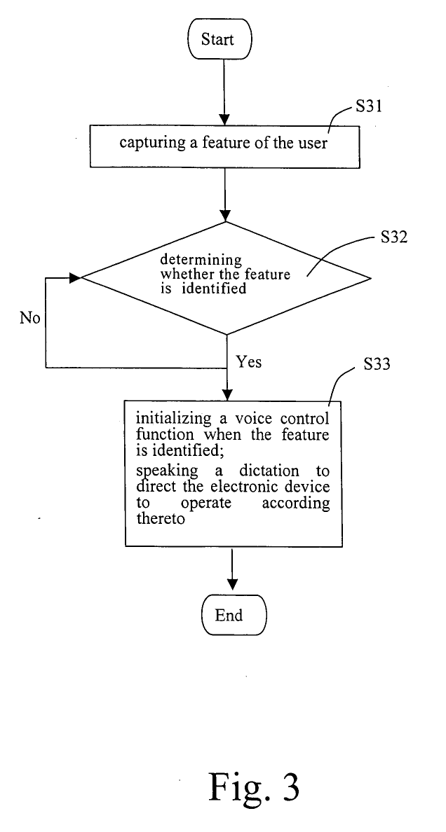

Referring to FIG. 3, a flowchart illustrating the voice control method performed in a personalization implementation according to the present invention is shown therein. At first, the electronic device captures a feature of the user (S31). Then, the electronic device determines whether the feature has been identified (S32). When the feature is determined as having been identified, a voice control function is initialized, and at this time, the user speaks his dictation and the electronic device is directed to operate according thereto (S33). The feature may be a sound, a face of the user and the like. The capturing step is performed in a stand-by mode with respect to the electronic device.

With the above methods performed, the electronic device may be more effectively and precisely controlled by sound speech, as compared to the prior art, since the feature captured before the dictation is inputted can be identified by the electronic device.

The present invention may be subject to modifications and alternations by persons skilled in the art, which should also be deemed as within the scope of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A voice control method for controlling an electronic device, comprising the steps of:
speaking a predetermined keyword by a user and then speaking a dictation for controlling the electronic device to operate according thereto;
inputting a predetermined action to the electronic device when the electronic device does not respond with respect to the predetermined keyword;
initializing a predetermined voice control function corresponding to the dictation by the electronic device in response to the predetermined action; and
speaking a dictation by the user to control the electronic device to operate according thereto.

2. The voice control method according to claim 1, further comprising the step of:
issuing a first response by the electronic device when the predetermined keyword is received.

3. The voice control method according to claim 1, further comprising the step of:
issuing a second response by the electronic device when the electronic device does not receive any dictation controlling the electronic device within a predetermined period.

4. The voice control method according to claim 3, further comprising the step of:
issuing a third response by the electronic device when the predetermined action is received.

5. According to the voice control method in claim 4, wherein the first response is a first sound, the second response is a second sound and the third response is a third sound.

6. According to the voice control method in claim 4, wherein the first response is a first predetermined window, the second response is a second window and the third response is a third predetermined window.

7. The voice control method according to claim 5, wherein the first sound is identical to the second sound and the third sound.

8. The voice control method according to claim 6, wherein the first predetermined window is identical to the second predetermined window and the third predetermined window.

9. The voice control method according to claim 1, wherein the predetermined action comprises a press action of a predetermined button and a clapping action.

10. A voice control method for controlling an electronic device, comprising the steps of:
capturing an image of a front view with respect to the electronic device; and
initializing a voice control function when the image is determined as a predetermined image; and
speaking a dictation by the user to control the electronic device to operate according thereto.

11. The voice control method according to claim 10, wherein the predetermined image is selected from a group consisting of an object image, a person image, a predetermined gesture image, a hand waving image and an image of a line of sight of the user.

12. The voice control method according to claim 10, further comprising a step prior to the capturing step:
setting the electronic device to a stand-by mode.

13. A voice control method for controlling an electronic device, comprising the steps of:
capturing a feature of the user;
initializing a voice control function when the feature is identified; and
speaking a dictation by the user to control the electronic device to operate according thereto.

14. The voice control method according to claim 13, further comprising a step prior to the capturing step:
setting the electronic device to a stand-by mode.

15. The voice control method according to claim 13, wherein the feature is one of a sound and a face.
